(19) United States
(12) Patent Application Publication
(10) Pub. No.: US 2020/0239761 A1
(43) Pub. Date: Jul. 30, 2020

(54) SYSTEM AND METHOD TO CURE DOWN HOLE LOSSES BY STIMULATION OF LOST CIRCULATION MATERIAL CONCENTRATION AT LOSS ZONE

(71) Applicants: Abdelkader Ferras, Chlef (DZ); Mohamed Ferras, Chlef (DZ)

(72) Inventors: Abdelkader Ferras, Chlef (DZ); Mohamed Ferras, Chlef (DZ)

(21) Appl. No.: 16/774,816

(22) Filed: Jan. 28, 2020

Related U.S. Application Data
(60) Provisional application No. 62/797,658, filed on Jan. 28, 2019.

(51) Int. Cl. C09K 8/487; C09K 8/516

(52) U.S. Cl. CPC C09K 8/487; C09K 8/516

(57) ABSTRACT

Different types of lost circulation materials (LCM) with various shapes and sizes may be used with different combinations and concentrations through different placement procedures to seal off down hole fractures. Lost circulation materials and/or systems may be formed of a combination of components including, but not limited to, a base fluid, a stabilizer, a dry LCM blend, and an activator. Using these types of improved LCMs may provide improved capability to seal off permeable and fractured formations having different fracture sizes.

### CROSS-REFERENCE TO RELATED APPLICATION

The present application claims priority to U.S. Provisional Application No. 62/797,658, filed Jan. 28, 2019, the disclosure of which is incorporated herein by reference in its entirety.

### FIELD OF THE DISCLOSURE

The present disclosure generally relates to lost circulation materials, and more particularly to stimulation of lost circulation material (LCM) concentration at a loss zone, thereby, improving the bridging efficiency of LCM pills.

### BACKGROUND

Drilling fluid is a fluid used while drilling oil and gas wells. This fluid is pumped down hole inside a pipe and a drilling tool (bit) to return up in the annulus between the pipe and the bore hole carrying the solids removed by the bit (cuttings) to surface, where they are separated from the drilling fluid which is recycled back into the well.

Fractures are open formations encountered while drilling. As drilling progresses in a downward direction, part or all the drilling fluid may be lost in a fracture. This may be referred to as lost circulation and can be a major problem in drilling operations. In the past, this problem has been tackled by pumping fluid generally mixed with some solids having different sizes and concentrations, which may be referred to as lost circulation materials (LCM), to reduce and eventually prevent the flow of drilling fluid into a weak, fractured or vugular formation. Thus, drilling fluid may be returned to the surface to be cleaned from the solids and recycled.

Performance of LCM pills are currently reduced due to the limited maximum concentration of the particulates in the LCM pill. This may be caused by mixing and pumping capability limitations as well as the sensitivity of down hole tools to solids with risk of plugging or eroding them. There is also a limitation on the size of the particulates in the LCM pill due to the limited size of internal diameter of drill pipe and down hole tools through which the LCM are pumped, thereby increasing the risk of plugging.

### SUMMARY

Embodiments of the present disclosure may provide different types of lost circulation materials (LCM) having various shapes and sizes that may be used with different combinations and concentrations through different placement procedures. For example, an LCM pill can be placed at balance followed by squeezing the LCM pill into the fracture. Additionally, or alternatively, an LCM pill can also be placed above the loss zone and then displaced down to the loss zone. In other embodiments of the present disclosure, and based of the identified risks, the placement of an LCM pill can also be tailored to the situation of the well to ensure safe operations while sealing off down hole fractures. Unlike conventional LCM pills or systems formed of a base fluid, viscosifier and particulates selected based on the Ideal Packing theory or/and Abraham's rule to suit for bridging special sizes of fracture apertures, in the embodiments of the present disclosure, LCM pills or systems may be formed of a combination of components including, but not limited to, a base fluid, a stabilizer, a selected dry LCM blend that may be suitable for larger range of fracture aperture sizes as embodiments of the present disclosure rely on small LCM sizes and special placement procedures in addition to utilization of an activator. Using these improved LCM pills according to embodiments of the present disclosure may provide improved capability to seal off permeable and fractured formations having different fracture sizes.

Embodiments of the present disclosure may provide a system for stimulation of lost circulation material (LCM) concentration at a loss zone, the system comprising: an LCM pill comprising a base fluid, a stabilizer, and a dry LCM blend having an adjustable particle size distribution (PSD); and an activator added to the LCM pill that activates the system to allow the agglomeration of the LCM at the loss zone to seal a fracture having a variable fracture size. The base fluid may be water in a water base mud (WBM) or oil in an oil base mud (OBM). The stabilizer may be a blend of viscosifiers, and the viscosifiers may be a combination of starch-derivative polymers and one or more other polymers in a WBM. The activator may be enzyme-based. The viscosifiers may be an organophilic clay in an OBM. The dry LCM blend may be acid-soluble, non-acid soluble, or a combination of acid-soluble and non-acid soluble. The LCM pill may be placed at balance and then squeezed into the fracture and/or the LCM pill may be placed above the loss zone and then displaced down to the loss zone. The LCM pill may have a maximum allowable LCM size and concentration of approximately 150-500 Kg/m3. The LCM particles in the LCM pill may agglomerate at the loss zone in approximately 15-120 minutes. LCM particles in the LCM pill may hold up to 500 psi.

Other embodiments of the present disclosure may provide a method for stimulation of lost circulation material (LCM) concentration at a loss zone, the method comprising: providing an LCM pill having uniform distribution of LCM particulates, the LCM pill comprising a base fluid, a stabilizer; and a dry LCM blend; introducing the LCM pill across the loss zone under bottom hole temperature; and adding an activator to the LCM pill, wherein LCM particles in the LCM pill may agglomerate inside a fracture leading to blockage of the fracture by forming a physical barrier that isolates a well bore from a deep thief zone. The method may further comprise adjusting a pumping rate, wherein a base fluid velocity may be sufficient to displace particulates in the fracture to displace settling inside the fracture. The LCM pill may have a maximum allowable LCM size and concentration of approximately 150-500 Kg/m3. LCM particles in the LCM pill may agglomerate after approximately 15-120 minutes. LCM particles in the LCM pill may hold up to 500 psi.

### BRIEF DESCRIPTION OF THE DRAWINGS

For a more complete understanding of this disclosure, reference is now made to the following description, taken in conjunction with the accompanying drawings, in which:

FIG. 1 depicts examples of LCMs with and without an activator according to an embodiment of the present disclosure;

FIG. 2A depicts inefficient bridging when the fracture size is bigger than the maximum possible particle size to be used;

FIG. 2B depicts inefficient bridging with the highest possible LCM concentration of the pill due to large fracture size;

FIG. 2C depicts efficient bridging using an LCM pill according to embodiments of the present disclosure due to agglomeration of the particulates inside the fracture;

FIG. 3 depicts a graph of reaction process versus time;

FIG. 4 depicts a valve system including a lower valve stem;

FIG. 5 depicts results of a high-pressure, high-temperature filtration (HPHT) test; and

FIGS. 6A-6F depict a bridging mechanism according to an embodiment of the present disclosure.

### DETAILED DESCRIPTION

Embodiments of the present disclosure may provide lost circulation material (LCM) systems formed of a combination of components including, but not limited to, a base fluid, a stabilizer, a selected dry LCM blend, and an activator. Using LCM systems according to embodiments of the present disclosure may provide improved capability to seal off permeable and fractured formations having different fracture sizes. This capability is improved relative to prior LCMs and related uncertainty of the fracture size, complexity of sealing mechanisms, and difficulty of control from the surface to de-fluidize the pill.

In some embodiments of the present disclosure, the base fluid may be water in the case of a water base mud (WBM) or oil for an oil base mud (OBM) in other embodiments of the present disclosure.

The stabilizer may be a blend of one or more viscosifiers. These viscosifiers may be a combination of starch-derivative polymers with other polymers in the case of a water base mud or an organophilic clay for an oil base mud. However, it should be appreciated that any viscosifier having a known breaker may be used as a stabilizer without departing from the present disclosure. The dry LCM blend may be acid-soluble, non-acid soluble, or a combination depending on specific application requirements in embodiments of the present disclosure. It should be appreciated that the particle size distribution (PSD) for the dry LCM blend may be adjusted depending on factors including, but not limited to, estimated fracture size or pore throat size. In embodiments of the present disclosure, the PSD of a selected LCM blend does not need to follow Abraham's Rule or Ideal Packing Theory, as particulates with sizes smaller than ⅓ of the fracture aperture might be efficient as well.

When a loss zone is encountered, it is important to keep the hole full so that the hydrostatic pressure does not fall below formation pressure and allow a kick to occur. The loss zone should be healed quickly and safely by using the LCM that conforms to the fracture to seal off pores, regardless what pressure changes may occur. Inclusion of an activator in the LCM according to embodiments of the present disclosure may activate the system to allow the agglomeration of the LCM at a loss zone to fit the fracture size, thereby sealing the fracture. It should be appreciated that the activator may be enzyme-based for water base mud when starch derivative viscosifiers are used in embodiments of the present disclosure.

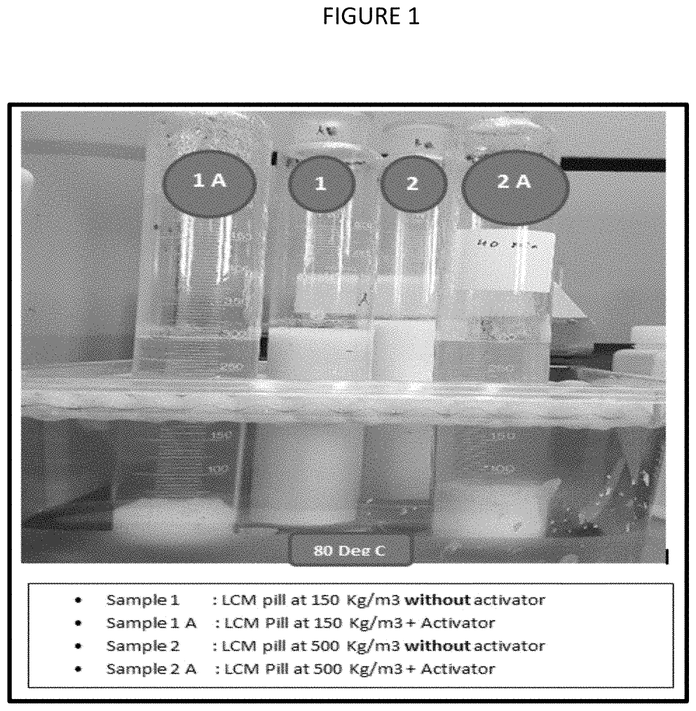

It should be appreciated that pumping rate may be adjusted so that the base fluid velocity will be sufficient to displace the particulates into the fracture to displace the settling inside the fracture rather than in the open hole building a “DELTA” sedimentation mechanism until pressure is built up. The “DELTA” effect may refer to pumping with a very slow pumping rate to drive the LCM to settle inside a fracture. This may provide for permanent bridging after drilling out the LCM plug. It should be appreciated that a hesitation squeeze at increments of 100-200 psi can be applied if required; this will further increase performance of the LCM according to embodiments of the present disclosure. It also should be appreciated that LCMs according to embodiments of the present disclosure may be limited to a maximum allowable LCM size and concentration (approximately 150-500 Kg/m3) depending on constraints associated with the down hole equipment, surface equipment, and/or pumping capabilities. However, through rearrangement of the particulates in the continuous phase of the LCM pill, these limitations may be addressed. More specifically, FIG. 1 provides examples of LCMs with and without an activator according to an embodiment of the present disclosure. Samples 1A and 2A contain an activator, while samples 1 and 2 do not contain an activator; however, all samples are exposed to the same temperature (80 degrees Celsius) and have the same concentration of LCM pill (500 kg/m³).

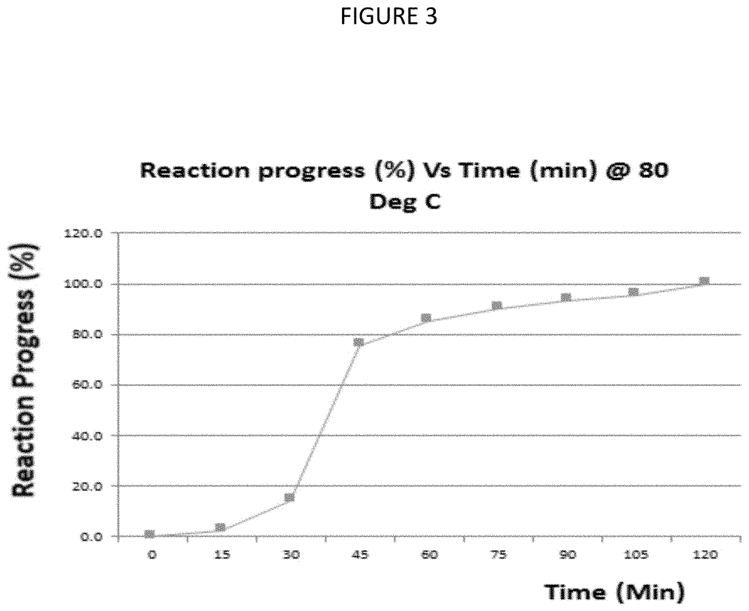

LCMs including an activator according to embodiments of the present disclosure may ensure the effectiveness and efficiency of the bridging through a mechanism described as follows. The LCM pill may be prepared with a selected particle size distribution (PSD) and concentration based on the predicted fracture size and limitations of mixing/pumping capabilities. The LCM pill having uniform distribution of the LCM particulates will then be chemically treated at surface by addition of the activator. The activator may react under down hole temperature after an adjustable period of time as per FIG. 3. Once the LCM pill has been introduced across the loss zone under bottom hole temperature, and after a predetermined period of time (approximately 15-120 minutes; however, it can be more in embodiments of the present disclosure), the LCM particles may begin to agglomerate, thereby leading to blockage of the fracture by forming a physical barrier that may isolate the well bore from the deep thief zone.

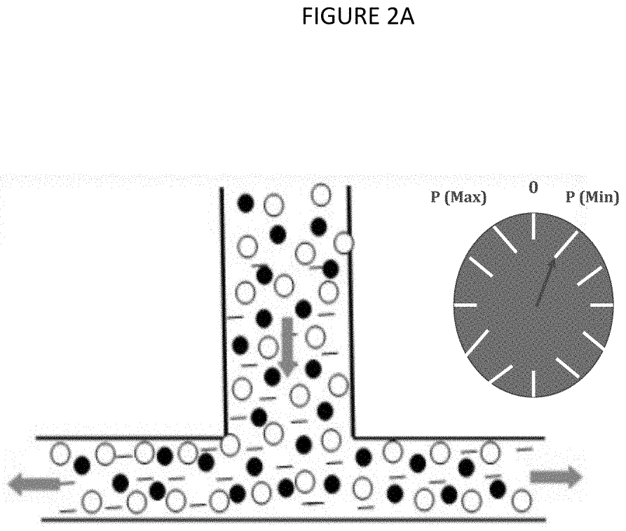

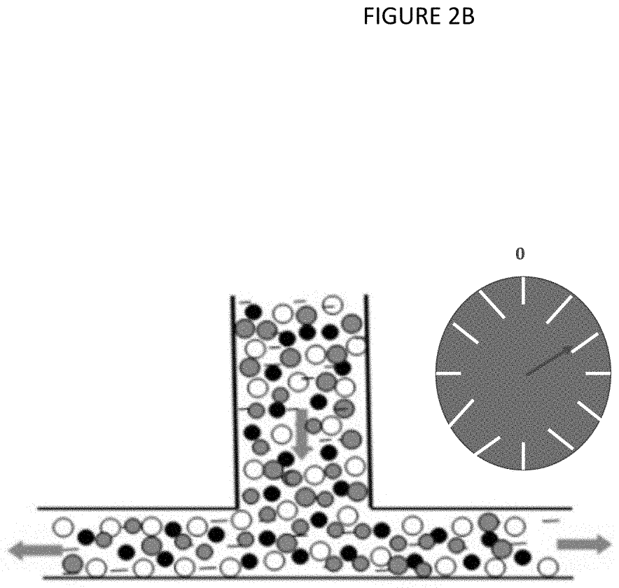

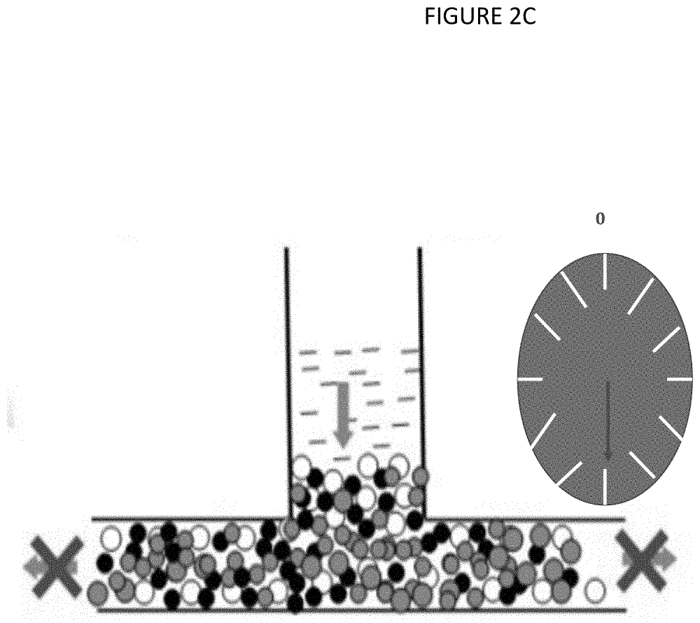

FIGS. 2A-2C provide a comparison of inefficient bridging when the fracture size is bigger than the maximum particle size (FIG. 2A), inefficient bridging with a high LCM concentration pill due to large fracture size (FIG. 2B), and efficient bridging using an LCM pill according to embodiments of the present disclosure due to agglomeration of the particulates inside the fracture (FIG. 2C).

Accordingly, LCM pills and/or systems including an activator according to embodiments of the present disclosure do not have to rely on the efficiency of a bridging mechanism which may introduce uncertainty as to estimated fracture size relative to the particle size distribution (PSD) and/or concentration of the LCM. Further, LCMs including an activator according to embodiments of the present disclosure are not dependent on the availability of a narrow throat (narrow section in the shallow depth of the fracture) relative to the bridging material's size to de-fluidize the pill so that the LCM particulates will accumulate into the fracture resulting in bridging the fracture.

While LCM pills or/and systems according to embodiments of the present disclosure may not change the concentration and size of the LCM particulates at the surface and/or while pumping, the agglomeration that occurs at the loss zone may provide improvements in both the concentration and the size of the LCM particulates, thereby leading to efficient plugging of a fracture at the loss zone.

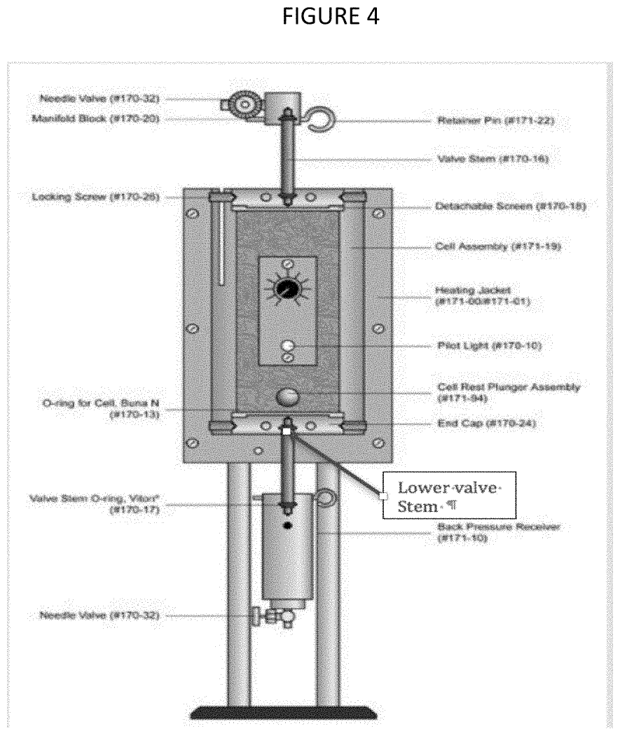

FIG. 3 depicts a graph of reaction process versus time. More specifically, FIG. 3 reflects the progress of the reactions of FIG. 1 over time; it reveals that the reaction starts after 15 minutes to be completed after 120 minutes of mixing time. FIG. 4 depicts a valve system including a lower valve stem that may be used to perform a high-pressure, high-temperature filtration (HPHT) test with results as depicted in FIG. 5 which proves that conventional samples (without activator) marked as samples 1 and 2 in FIG. 1 are unable to seal off the open valve even with only 200 PSI where the graduated cylinder of 50 cc was completely filled. In contrast, activated samples 1A and 2A as per embodiments of the present disclosure sealed off perfectly the open valve with maximum recovered fluid of 5 cc even under higher pressure of 500 PSI. The lab testing indicates that agglomeration occurs at different temperatures and with different concentrations. Further, lab testing demonstrates the efficiency of the LCM. More specifically, as depicted in FIG. 5, the LCM particulates may hold up to 500 Psi in embodiments of the present disclosure.

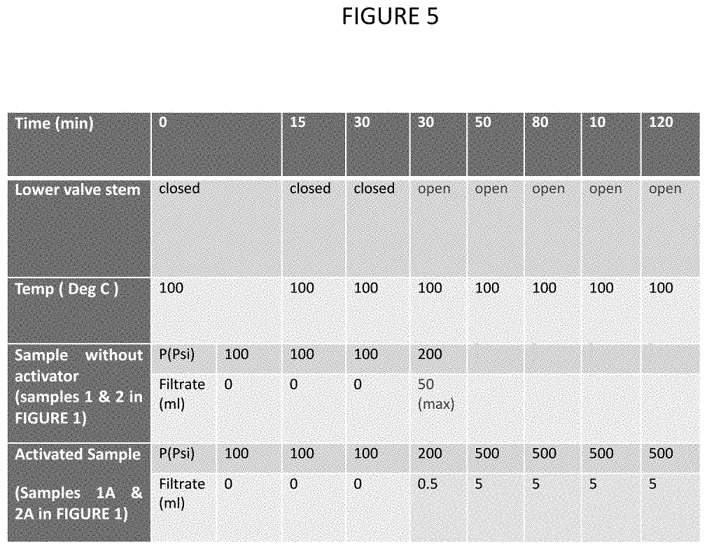

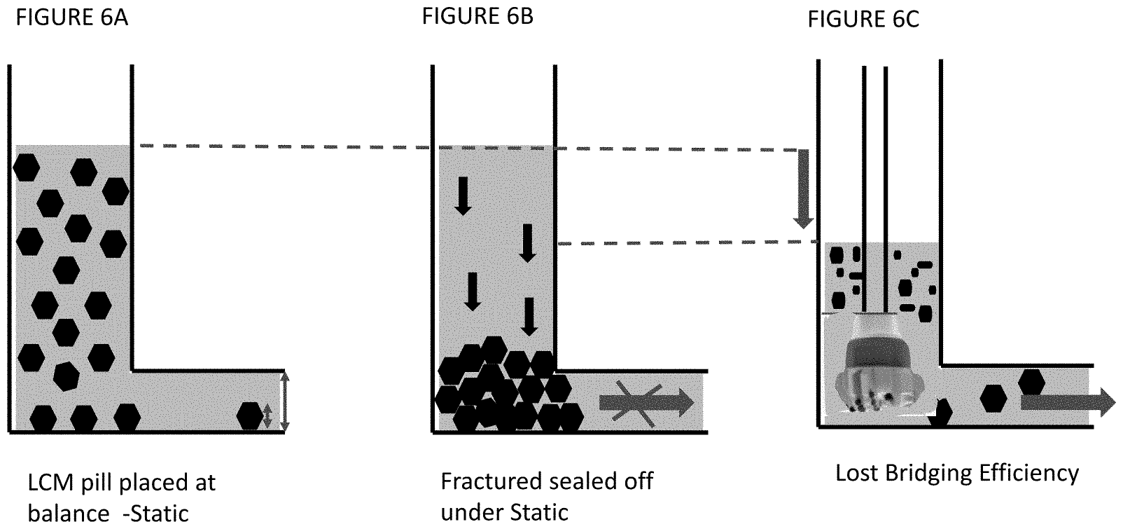

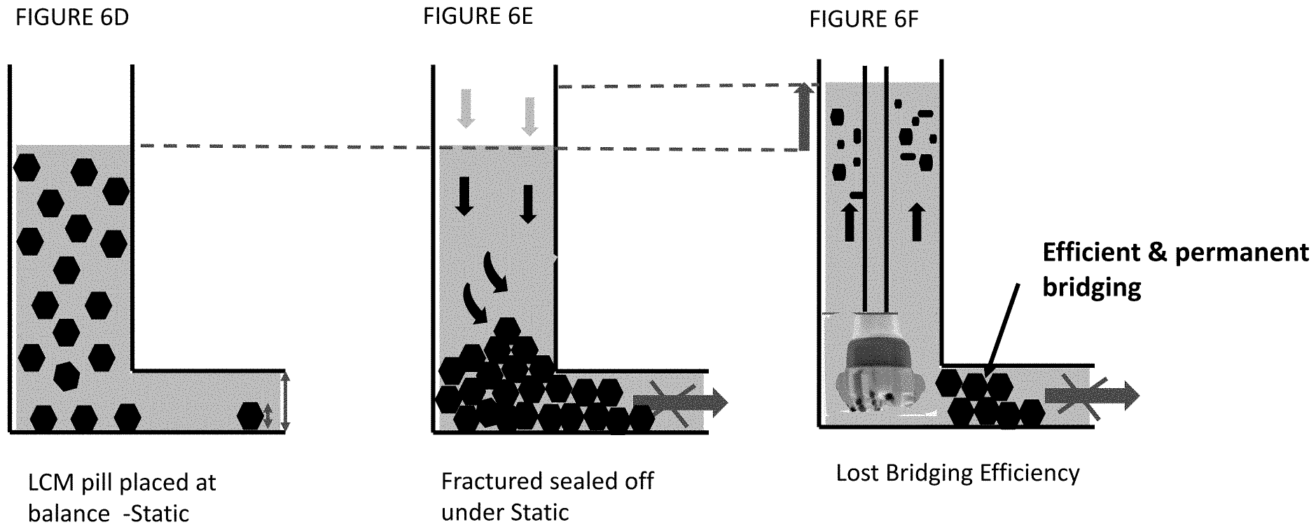

FIGS. 6A and 6D reflect an LCM pill placed at balance—static. As reflected in FIG. 6B, under the effect of the activator, LCM particulates may agglomerate at the bottom, thereby sealing off (bridging) the fracture. In FIG. 6C, the bridging effect may cease after drilling out the agglomerated LCM particulates at the bottom, which reintroduces the loss problem. The “DELTA” effect is depicted in FIG. 6E, which refers to pumping with a very slow pumping rate to drive the LCM to settle inside the fracture. FIG. 6F depicts effective permanent bridging after drilling out the LCM plug in an embodiment of the present disclosure.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A system for stimulation of lost circulation material (LCM) concentration at a loss zone, the system comprising:
an LCM pill comprising a base fluid, a stabilizer, and a dry LCM blend having an adjustable particle size distribution (PSD); and
an activator added to the LCM pill that activates the system to allow the agglomeration of the LCM at the loss zone to seal a fracture having a variable fracture size.

2. The system of claim 1, wherein the base fluid is water in a water base mud (WBM).

3. The system of claim 1, wherein the base fluid is oil in an oil base mud (OBM).

4. The system of claim 1, wherein the stabilizer is a blend of viscosifiers.

5. The system of claim 4, wherein the viscosifiers are a combination of starch-derivative polymers and one or more other polymers in a WBM.

6. The system of claim 5, wherein the activator is enzyme-based.

7. The system of claim 4, wherein the viscosifiers are an organophilic clay in an OBM.

8. The system of claim 1, wherein the dry LCM blend is acid-soluble, non-acid soluble, or a combination of acid-soluble and non-acid soluble.

9. The system of claim 1, wherein the LCM pill is placed at balance and then squeezed into the fracture.

10. The system of claim 1, wherein the LCM pill is placed above the loss zone and then displaced down to the loss zone.

11. The system of claim 1, wherein the LCM pill has a maximum allowable LCM size and concentration of approximately 150-500 Kg/m3.

12. The system of claim 1, wherein LCM particles in the LCM pill agglomerate at the loss zone in approximately 15-120 minutes.

13. The system of claim 1, wherein LCM particles in the LCM pill hold up to 500 psi.

14. A method for stimulation of lost circulation material (LCM) concentration at a loss zone, the method comprising:
providing an LCM pill having uniform distribution of LCM particulates, the LCM pill comprising a base fluid, a stabilizer; and a dry LCM blend;
introducing the LCM pill across the loss zone under bottom hole temperature; and
adding an activator to the LCM pill, wherein LCM particles in the LCM pill agglomerate inside a fracture leading to blockage of the fracture by forming a physical barrier that isolates a well bore from a deep thief zone.

15. The method of claim 14 further comprising:
adjusting a pumping rate, wherein a base fluid velocity is sufficient to displace particulates in the fracture to displace settling inside the fracture.

16. The method of claim 14, wherein the LCM pill has a maximum allowable LCM size and concentration of approximately 150-500 Kg/m3.

17. The method of claim 14, wherein LCM particles in the LCM pill agglomerate after approximately 15-120 minutes.

18. The method of claim 14, wherein LCM particles in the LCM pill hold up to 500 psi.
